(19) United States
(12) Patent Application Publication
(10) Pub. No.: US 2025/0028980 A1
(43) Pub. Date: Jan. 23, 2025

(54) MACHINE LEARNING TECHNIQUES FOR FEATURE PREDICTION BASED ON CLUSTERING USING ANCILLARY AND LOCATION DATA

(71) Applicant: UnitedHealth Group Incorporated, Minnetonka, MN (US)

(72) Inventors: Kurt Johnson, Scottsdale, AZ (US); Chiranjeev Pahuja, Gurugram (IN); Krishna Naveen Kumar Kamatam, Hyderabad (IN); Elena Li, Canton, OH (US)

(21) Appl. No.: 18/355,820

(22) Filed: Jul. 20, 2023

(51) Int. Cl. G06N 5/022

(52) U.S. Cl. CPC G06N 5/022

(57) ABSTRACT

Various embodiments of the present disclosure provide methods, apparatus, systems, computing devices, computing entities, and/or the like for a predictive data analysis system that is configured to rank one or more candidate entities. A machine learning model is trained to rank the one or more candidate entities for initiating the performance of one or more prediction-based actions based on one or more sets of a plurality of clusters generated based on population data merged with ancillary data, and an association of location data with external domain data. The plurality of clusters is generated by generating embeddings for one or more features associated with a plurality of entities selected for clustering and determining a similarity score for entity pairs selected from the plurality of entities based on a distance function and the embeddings.

### BACKGROUND

Various embodiments of the present disclosure address technical challenges related to performing predictive data analysis and provide solutions to address the efficiency and reliability shortcomings of existing predictive data analysis solutions.

### BRIEF SUMMARY

In general, various embodiments of the present disclosure provide methods, apparatus, systems, computing devices, computing entities, and/or the like for performing predictive operations on candidate entities.

In some embodiments, a computer-implemented method comprises: merging, by the one or more processors, population data with ancillary data from a first ancillary dataset and a second ancillary dataset, wherein (i) the population data has been extracted from a population dataset, and (ii) the populating dataset comprises location and feature information associated with a plurality of entities; generating, by the one or more processors, location data associated with the plurality of entities based on the merged population data; associating, by the one or more processors, the location data with external domain data; determining, by the one or more processors, a plurality of distances between the plurality of entities based on the location data; generating, by the one or more processors, one or more sets of a plurality of clusters, each set comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and initiating, by the one or more processors, the performance of one or more prediction-based actions based on the ranking of the one or more candidate entities.

In some embodiments, a computing apparatus comprising memory and one or more processors communicatively coupled to the memory, the one or more processors configured to: merge population data with ancillary data from a first ancillary dataset and a second ancillary dataset, wherein (i) the population data has been extracted from a population dataset, and (ii) the populating dataset comprises location and feature information associated with a plurality of entities; generate location data associated with the plurality of entities based on the merged population data; associate the location data with external domain data; determine a plurality of distances between the plurality of entities based on the location data; generate one or more sets of a plurality of clusters, each set comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and initiate the performance of one or more prediction-based actions based on the ranking of the one or more candidate entities.

In some embodiments, one or more non-transitory computer-readable storage media including instructions that, when executed by one or more processors, cause the one or more processors to: merge population data with ancillary data from a first ancillary dataset and a second ancillary dataset, wherein (i) the population data has been extracted from a population dataset, and (ii) the populating dataset comprises location and feature information associated with a plurality of entities; generate location data associated with the plurality of entities based on the merged population data; associate the location data with external domain data; determine a plurality of distances between the plurality of entities based on the location data; generate one or more sets of a plurality of clusters, each set comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and initiate the performance of one or more prediction-based actions based on the ranking of the one or more candidate entities.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for performing predictive operations on candidate entities in accordance with some embodiments of the present disclosure.

FIG. 5 is a flowchart diagram of an example process for generating clustering parameters in accordance with some embodiments of the present disclosure.

FIG. 6 is an operational example of a entity feature prediction machine learning framework in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### III. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

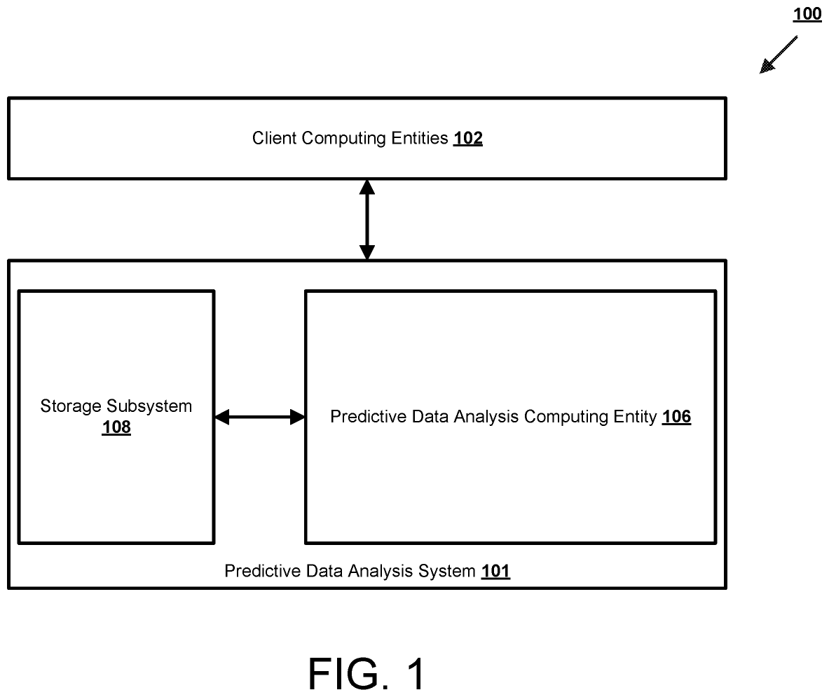

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically initiate performance of prediction-based actions based on the generated predictions.

An example of a prediction-based action that can be performed using the predictive data analysis system 101 comprises receiving a request for ranking one or more candidate entities for allocation of one or more resources and predicting shared features with one or more clusters, and displaying predicted shared features along with associated one or more resources on a user interface. Other examples of prediction-based actions comprise generating a diagnostic report, displaying/providing resources, generating and/or executing action scripts, generating alerts or reminders, or generating one or more electronic communications based on the ranking of the one or more candidate entities.

In accordance with various embodiments of the present disclosure, a predictive machine learning model may be trained to predict whether candidate entities require resources based on ancillary features that do not explicitly indicate, but may implicitly imply, a need for one or more resources. Candidate entities may be ranked based on their similarity to entities clustered based on ancillary features combined with location data. This technique will lead to improved and more insightful detection of resource needs. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically initiate performance of prediction-based actions based on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### A. Example Predictive Data Analysis Computing Entity

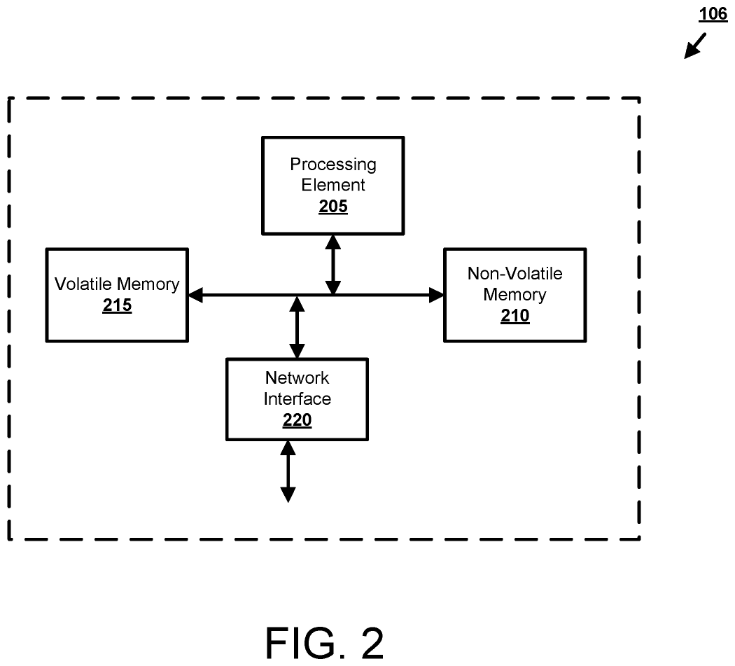

FIG. 2 provides a schematic of a predictive data analysis computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes can be performed on data, content, information, and/or similar terms used herein interchangeably.

As shown in FIG. 2, in some embodiments, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the predictive data analysis computing entity 106 may further include, or be in communication with, non-volatile media (also referred to as non-volatile storage, memory, memory storage, memory circuitry and/or similar terms used herein interchangeably). In some embodiments, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the predictive data analysis computing entity 106 may further include, or be in communication with, volatile media (also referred to as volatile storage, memory, memory storage, memory circuitry and/or similar terms used herein interchangeably). In some embodiments, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in some embodiments, the predictive data analysis computing entity 106 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### B. Example Client Computing Entity

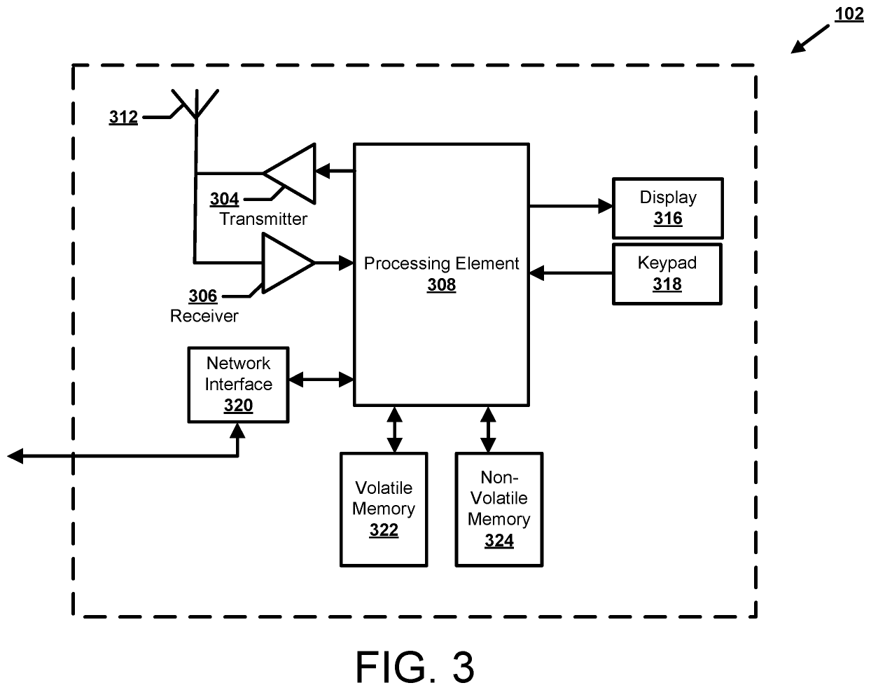

FIG. 3 provides an illustrative schematic representative of a client computing entity 102 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile memory 322 and/or non-volatile memory 324, which can be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for example purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “population dataset” may refer to a collection of data associated with characteristics or features of one or more entities. According to various embodiments of the present disclosure, population data comprises data that identifies or characterizes respective ones of one or more entities belonging to a group. As an example, population data may comprise, among other types of information, location and feature information that may be collected on or received from one or more entities. A group may be representative of an organization of one or more entities. In some embodiments, entities in a group may belong to, be serviced by, be affiliated with, or otherwise be associated with a resource or service provider. Population data may be stored, maintained, and under control of a resource or service provider.

In some embodiments, the term “population data” may refer to at least a portion of a population dataset.

In some embodiments, the term “location and feature information” may refer to at least a portion of population data comprising (i) locations of one or more entities, and (ii) descriptive or qualitative features of the one or more entities. According to various embodiments of the present disclosure, location and feature information comprises addresses (either virtual or physical), identifiers, types, configurations or settings, age, versions, and any other type of specification information apparent to one of ordinary skill in the art. In some embodiments, location and feature information may also comprise a postal address and demographic statistics.

In some embodiments, the term “entity” may refer to a data construct that describes an object, article, file, program, service, task, operation, computing, and/or the like unit that may require and/or consume one or more resources to execute an operation, perform a task, maintain or advance a state, or continue functioning. An entity may require a resource either upon a given condition or periodically (e.g., as maintenance or preventative care). According to various embodiments of the present disclosure, a computing device performs a prediction-based action associated with a resource allocated towards an entity based on a prediction or determination that the entity requires such resource. In some embodiments, a prediction machine learning model may be trained to rank one or more candidate entities for initiating the performance of one or more prediction-based actions based on the ranking of the one or more candidate entities.

In some embodiments, the term “ancillary dataset” may refer to a collection of data distinct from a population dataset. Ancillary datasets and a population dataset may be associated with, owned, controlled, stored, and/or maintained, for example, by a same resource or service provider. An ancillary dataset may comprise data used to supplement population data. According to various embodiments of the present disclosure, population data is merged with one or more ancillary datasets. Examples of data comprised in ancillary datasets include, but not limited to, operating condition or status data, diagnostics and history data, ratings and performance data, and classification data. In another example, ancillary datasets may comprise social determinants of health data, clinical profile data, and risk adjustment factor data.

In some embodiments, the term “ancillary data” may refer to at least a portion of one or more ancillary datasets.

In some embodiments, the term “location data” may refer to data that describes an identification of a real-world geographic or virtual location of an object. For example, location data may comprise a set of geographic coordinates, such as latitude and longitude, or one or more alphanumeric identifiers. Location data may be determined and/or collected via either active user/device-based information, or passive server-based lookup/data correlation. According to various embodiments of the present disclosure, location data is determined based on data (e.g., population data and/or ancillary datasets) comprising postal address, Global Positioning System (GPS) data, Internet Protocol (IP) address, Media Access Control (MAC) address, Radio Frequency (RF) systems, or metadata from files in formats, such as Exchangeable Image File Format (EXIF).

In some embodiments, the term “external domain data” may refer to data distinct from population data and ancillary data. External domain data may be associated with, owned, controlled, stored, and/or maintained by, for example, a resource or service provider different from a resource or service provider associated with (as well as own, control, store, and/or maintain) a population dataset and one or more ancillary datasets. In some embodiments, external domain data may comprise open-source data, third-party data, or public domain data. Examples of external domain data include, but not limited to, census data, community-contributed data, survey data, or statistical data for census tracts/blocks.

In some embodiments, the term “cluster” may refer to a data construct that describes a group of similar entities. Clusters may be generated, for example, by using a clustering machine learning model and grouping a plurality of specific entities selected for clustering into the clusters based on similarity. Certain entities associated with selected features may be selected as a training dataset for clustering by a clustering machine learning model. Entities may be grouped into clusters such that entities in a given cluster are more similar to each other compared to entities in other clusters. Similarity between entities may be determined by comparing features of the entities. Features for comparing entities may be associated with population data, ancillary data, and external domain data. Similarity between a pair of entities, with respect to a set of features, may be determined with a similarity score based on the set of features. A pair of entities may be determined to be similar based on a similarity score between the pair of entities being above a predetermined threshold. That is, a similarity score above the predetermined threshold may be representative of the pair of entities having a set of features that are substantially shared (or similar) between the pair of entities. Accordingly, a cluster may comprise a plurality of entities comprising per-cluster set similarity scores, relative to each entity within the cluster, which are of at least a predetermined threshold. Moreover, entities may be determined as similar in different aspects depending on various sets of features (e.g., per-cluster set). As such, a plurality of cluster sets may be generated based on a plurality of respective sets of features used to determine a plurality of per-cluster set similarity scores. According to various embodiments of the present disclosure, one or more sets of a plurality of clusters are generated, each set comprising respective ones of a plurality of entities and, wherein (i) one of the one or more sets of the plurality of clusters is generated based on respective ones of a plurality of distances associated with the respective ones of the plurality of entities are within a relative distance boundary, and (ii) the respective ones of the plurality of entities comprises a first set of shared features or a second set of shared features. The first set of shared features and the second set of shared features may be determined based on merged population data, and an association of location data with external domain data. In some embodiments, the respective ones of the plurality of entities further comprises a third set of shared features, wherein the third set of shared features comprises an absence of the first set of shared features or an absence of the second set of shared features.

In some embodiments, the term “clustering machine learning model” may refer to a data construct that describes parameters, hyperparameters, and/or defined operations of a machine learning model that is configured to generate clusters from a plurality of entities. According to various embodiments of the present disclosure, a clustering machine learning model generates one or more clusters from a plurality of entities by receiving the plurality of entities in the form of embeddings, determining similarity scores between the plurality of entities by applying a distance function to the embeddings, and generating the one or more clusters based on the similarity scores. A clustering machine learning model may apply a clustering algorithm (e.g., k-means clustering, mean-shift clustering, Gaussian mixture models, or hierarchical clustering) that uses similarity scores between a plurality of entities to cluster the plurality of entities.

In some embodiments, the term “similarity score” may refer to a data construct that describes a value corresponding to a measurement of similarity, or a strength of relationship, between a pair of entities. Similarity scores of a plurality of entities may be used by a clustering machine learning model to group the plurality of entities into clusters. According to various embodiments of the present disclosure, a similarity score between a pair of entities may be determined based on a comparison of their features (e.g., a set of features). In some embodiments, determining a similarity score between a pair of entities may comprise generating embeddings, e.g., using an embedding machine learning model, associated with a given set of features, selected as a basis for similarity comparison, for the pair of entities. As such, a similarity score between the pair of entities may be determined by using a distance function with the embeddings of the given features associated with the pair of entities. A distance function may comprise a mathematical formula that can be used to calculate a distance between the embeddings of the given features associated with the pair of entities, such as Euclidean distance, Manhattan distance, Minkowski distance, Jaccard distance, Cosine similarity, and any other types of distance measurements apparent to one of ordinary skill in the art.

In some embodiments, the term “embedding” may refer to a data construct that describes a numerical representation of one or more features associated with an entity. For example, an embedding of an entity may be expressed as a vector comprising one or more numbers representative of one or more features associated with the entity. In some embodiments, an embedding comprises a mapping of one or more features to one or more elements in a vector space. According to various embodiments of the present disclosure, embeddings may be generated for a pair of entities and used with a distance function to determine a similarity score between the pair of entities.

In some embodiments, the term “embedding machine learning model” may refer to a data construct that describes parameters, hyperparameters, and/or defined operations of a machine learning model that is configured to generate an embedding representative of one or more features associated with an entity. For example, an embedding machine learning model may be trained to convert entity features associated with population data, ancillary data, and external domain data into an embedding vector. As such, an embedding machine learning model may be configured to translate a plurality of features into a relatively low-dimensional vector space in the form of an embedding.

In some embodiments, the term “distance boundary” may refer to a data construct that describes a geographical area within a boundary relative to a particular geographical point. For example, a distance boundary may comprise a radius around a central geographical point. A distance boundary may comprise a geographical area bounded by any of a variety of shapes, either regular, or irregular.

In some embodiments, the term “set of shared features” may refer to a data construct that describes a condition associated with a plurality of entities within a given cluster representative of the plurality of entities having same of one or more features or missing same of one or more features. A plurality of cluster sets may be generated for a plurality of respective sets of given features. For example, a pair of entities may be determined to have one or more sets of shared features by determining one or more similarity scores for the pair of entities based on embeddings of respective one or more given sets of features associated with the pair of entities. As such, the pair of entities may be grouped into one or more cluster sets based on a similarity score for each of the one or more given sets of features meeting a threshold criterion. According to various embodiments of the present disclosure, a set of shared features is determined based on (a) population data merged with ancillary data from a first ancillary dataset and a second ancillary dataset, and (b) an association of location data with external domain data. In some embodiments, a set of shared features may be associated with ancillary data from a particular ancillary dataset. A set of shared features for clustering may be determined for data features of a variety of domains. In some example embodiments, a first set of shared features is associated with enrollment plans (e.g., Medicare Savings Program, Low-Income Subsidy, or dual plans) or barrier features (e.g., financial, education, or employment) associated with a first ancillary dataset comprising social determinants of health data, and a second set of shared features is associated with profile features (e.g., clinical profile including medical conditions, pharmacy utilization, emergency room visits, in-patient visits, or risk score based on clinical conditions) associated with a second ancillary dataset associated with clinical data. According to some alternative embodiments, a set of shared features may be associated with a combination of ancillary data from a plurality of ancillary datasets, such as a combination of the first ancillary dataset and the second ancillary dataset.

In some embodiments, the term “entity feature prediction machine learning framework” may refer to a data construct that describes parameters, hyperparameters, and/or defined operations of a machine learning model that is configured to merge population data with ancillary data from a first ancillary dataset and a second ancillary dataset, generate location data associated with the plurality of entities based on the merged population data, associate the location data with external domain data, determine a plurality of distances between the plurality of entities based on the location data, generate one or more sets of a plurality of clusters, each set comprising respective ones of the plurality of entities, wherein the one or more sets of the plurality of clusters is usable to train a prediction machine learning model to rank one or more candidate entities, and initiate the performance of one or more prediction-based actions based on the ranking of the one or more candidate entities.

In some embodiments, the term “prediction machine learning model” may refer to a data construct that describes parameters, hyperparameters, and/or defined operations of a machine learning model that is configured to rank one or more candidate entities based on one or more sets of a plurality of clusters. Ranking the one or more candidate entities may comprise generating a prediction based on a relevance score, e.g., using a distance function, between the one or more candidate entities and a plurality of entities associated with one or more specific clusters from one or more sets of a plurality of clusters. According to various embodiments of the present disclosure, a prediction machine learning model may be trained with one or more sets of a plurality of clusters, where each set of the plurality of clusters may be associated with a selected set of shared features. A prediction machine learning model may also be trained with a plurality of entities or one or more clusters identified (e.g., labeled) as not associated with respective one or more sets of shared features. In some embodiments, a prediction machine learning model may rank one or more candidate entities based on relevance with respect to one or more specific sets of shared features. For example, a prediction machine learning model may be trained to (i) rank one or more first candidate entities with respect to a first set of shared entities based on a first training dataset comprising a first set of clusters generated based on the first set of shared features, and (ii) rank one or more second candidate entities with respect to a second set of shared entities based on a second training dataset comprising a second set of clusters generated based on the second set of shared features. In some additional embodiments, a prediction machine learning model may generate a composite ranking of one or more candidate entities based on relevance with respect to a plurality of sets of shared features (e.g., the first set of shared features and the second set of shared features). In some embodiments, a prediction machine learning model comprises an ensemble machine learning model based on decision tree learning, such as gradient boosting, extreme gradient boosting, or random forest.

In some embodiments, the term “candidate entity” may refer to a data construct that describes one of a plurality of entities comprising a prediction dataset selected for ranking. A candidate entity may be ranked based on its similarity to a plurality of entities associated with one or more specific clusters from one or more sets of a plurality of clusters. In some embodiments, a candidate entity may be representative of an entity requiring a resource. According to various embodiments of the present disclosure, a prediction machine learning model is trained to rank one or more candidate entities such that one or more prediction-based actions may be performed to allocate one or more resources may be initiated based on the ranking of the one or more candidate entities.

### IV. Overview, Technical Improvements, and Technical Advantages

Various embodiments of the present disclosure make important technical contributions to improving predictive ability and accuracy of predictive machine learning models by incorporating ancillary data with location data. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

For example, various embodiments of the present disclosure improve predictive accuracy of predictive machine learning models by incorporating ancillary data with location data. As described herein, feature engineering may be performed to extract and select features from input data to improve a machine learning model's predictive performance. Training a machine learning model based on only features directly related to a prediction target, though effective to a certain degree, may not fully capture the context of the variables to provide an insightful prediction. That is, ancillary features and location data may not comprise data directly related to a prediction target but may influence the prediction target. Furthermore, certain kinds of data, such as data comprising complex interdependencies and relationships may make it difficult to select features deemed pertinent to a prediction target. For this reason, it is important to have techniques available that leverages a wider range of features for enhancing machine learning model accuracy.

In accordance with various embodiments of the present disclosure, a predictive machine learning model may be trained to predict whether candidate entities require resources based on ancillary features that do not explicitly indicate, but may implicitly imply, a need for one or more resources. Candidate entities may be ranked based on their similarity to entities clustered based on ancillary features combined with location data. This technique will lead to improved and more insightful detection of resource needs. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

### V. Example System Operations

As indicated, various embodiments of the present disclosure make important technical contributions to improving predictive ability and accuracy of predictive machine learning models by incorporating ancillary data with location data. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

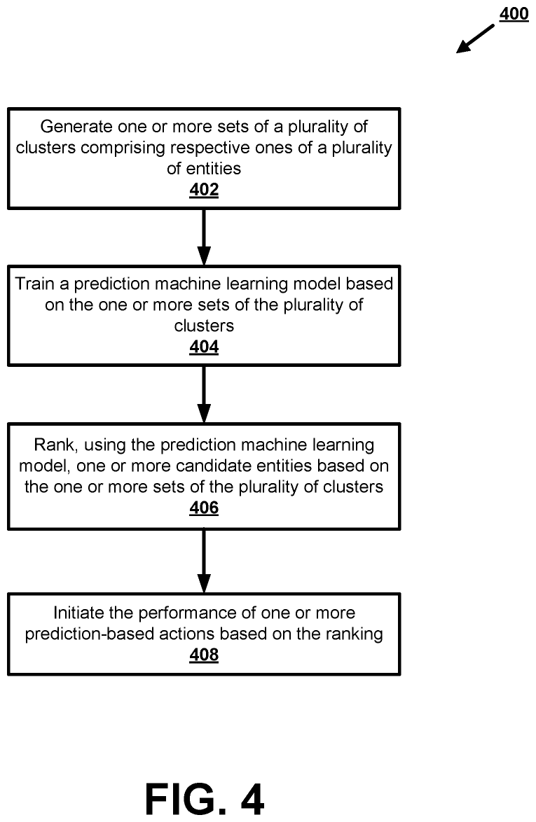

FIG. 4 is a flowchart diagram of an example process 400 for performing predictive operations on candidate entities. In some embodiments, via the various steps/operations of the process 400, the predictive data analysis computing entity 106 can use an entity feature prediction machine learning framework to generate one or more sets of a plurality of clusters, each set comprising respective ones of the plurality of entities usable to train a prediction machine learning model based on the one or more sets of the plurality of clusters to rank one or more candidate entities based on the one or more sets of the plurality of clusters.

In some embodiments, the process 400 begins at step/operation 402 when the predictive data analysis computing entity 106 generates one or more sets of a plurality of clusters, each set comprising respective ones of the plurality of entities.

In some embodiments, an entity describes an object, article, file, program, service, task, operation, computing, and/or the like unit that may require and/or consume one or more resources to execute an operation, perform a task, maintain or advance a state, or continue functioning. An entity may require a resource either upon a given condition or periodically (e.g., as maintenance or preventative care). According to various embodiments of the present disclosure, a computing device performs a prediction-based action associated with a resource allocated towards an entity based on a prediction or determination that the entity requires such resource. In some embodiments, a prediction machine learning model may be trained to rank one or more candidate entities for initiating the performance of one or more prediction-based actions based on the ranking of the one or more candidate entities.

In some embodiments, a cluster describes a group of similar entities. Clusters may be generated, for example, by using a clustering machine learning model and grouping a plurality of specific entities selected for clustering into the clusters based on similarity. Certain entities associated with selected features may be selected as a training dataset for clustering by a clustering machine learning model. Entities may be grouped into clusters such that entities in a given cluster are more similar to each other compared to entities in other clusters. Similarity between entities may be determined by comparing features of the entities. Features for comparing entities may be associated with population data, ancillary data, and external domain data. Similarity between a pair of entities, with respect to a set of features, may be determined with a similarity score based on the set of features. A pair of entities may be determined to be similar based on a similarity score between the pair of entities being above a predetermined threshold. That is, a similarity score above the predetermined threshold may be representative of the pair of entities having a set of features that are substantially shared (or similar) between the pair of entities. Accordingly, a cluster may comprise a plurality of entities comprising per-cluster set similarity scores, relative to each entity within the cluster, which are of at least a predetermined threshold. Moreover, entities may be determined as similar in different aspects depending on various sets of features (e.g., per-cluster set). As such, a plurality of cluster sets may be generated based on a plurality of respective sets of features used to determine a plurality of per-cluster set similarity scores.

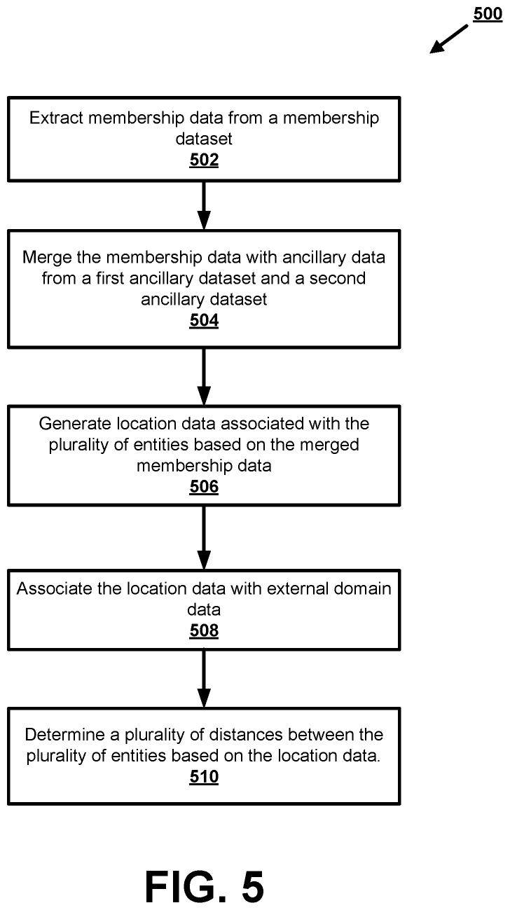

According to various embodiments of the present disclosure, the predictive data analysis computing entity 106 can generate a plurality of clusters based on clustering parameters, such as (i) respective ones of a plurality of distances associated with respective ones of a plurality of entities being within a relative distance boundary based on refinement criteria, and (ii) the respective ones of the plurality of entities comprising a first set of shared features or a second set of shared features. For example, embodiments of the present disclosure may be used to cluster members of a population. In one example embodiment, the predictive data analysis computing entity 106 may generate clusters of members with a first set of shared features comprising similar clinical profile and not identified/outreached for barriers, and within a given radius based on refinement criteria, such as demographics (e.g., age, or gender). In another example embodiment, the predictive data analysis computing entity 106 may generate clusters of members with a second set of shared features comprising similar barrier profile and within a given radius based on refinement criteria, such as demographics (e.g., age, or gender). In another example embodiment, the predictive data analysis computing entity 106 may generate clusters of members with a third set of shared features comprising no barrier profile and within a given radius based on refinement criteria, such as demographics (e.g., age, or gender). In yet another example embodiment, the predictive data analysis computing entity 106 may generate clusters of members with a fourth set of shared features comprising no clinical conditions and within a given radius based on refinement criteria, such as demographics (e.g., age, or gender). Clustering parameters are described in further detail with respect to the description of FIG. 5.

In some embodiments, a set of shared features describes a condition associated with a plurality of entities within a given cluster representative of the plurality of entities having same of one or more features or missing same of one or more features. A plurality of cluster sets may be generated for a plurality of respective sets of given features. For example, a pair of entities may be determined to have one or more sets of shared features by determining one or more similarity scores for the pair of entities based on embeddings of respective one or more given sets of features associated with the pair of entities. As such, the pair of entities may be grouped into one or more cluster sets based on a similarity score for each of the one or more given sets of features meeting a threshold criterion.

According to various embodiments of the present disclosure, a set of shared features is determined based on (a) population data merged with ancillary data from a first ancillary dataset and a second ancillary dataset, and (b) an association of location data with external domain data. In some embodiments, a set of shared features may be associated with ancillary data from a particular ancillary dataset. A set of shared features for clustering may be determined for data features of a variety of domains. In some example embodiments, a first set of shared features is associated with enrollment plans (e.g., Medicare Savings Program, Low-Income Subsidy, or dual plans) or barrier features (e.g., financial, education, or employment) associated with a first ancillary dataset comprising social determinants of health data, and a second set of shared features is associated with profile features (e.g., clinical profile including medical conditions, pharmacy utilization, emergency room visits, in-patient visits, or risk score based on clinical conditions) associated with a second ancillary dataset associated with clinical data. According to some alternative embodiments, a set of shared features may be associated with a combination of ancillary data from a plurality of ancillary datasets, such as a combination of the first ancillary dataset and the second ancillary dataset.

In some embodiments, the predictive data analysis computing entity 106 may further generate one or more sets of a plurality of clusters, each set comprising respective ones of a plurality of entities, wherein a first one of the one or more sets may be clustered based on first clustering parameters comprising a first set of shared features and a second one of the one or more sets may be clustered based on second clustering parameters comprising a second set of shared features. For example, the predictive data analysis computing entity 106 may perform multi-clustering of entities having a variety of values associated with a first set of shared features and a first relative distance boundary from each other, and perform multi-clustering of entities having a variety of values associated with a second set of shared features and a second (or the first) relative distance boundary from each other.

In some embodiments, a clustering machine learning mode describes parameters, hyperparameters, and/or defined operations of a machine learning model that is configured to generate clusters from a plurality of entities. According to various embodiments of the present disclosure, a clustering machine learning model generates one or more clusters from a plurality of entities by receiving the plurality of entities in the form of embeddings, determining similarity scores between the plurality of entities by applying a distance function to the embeddings, and generating the one or more clusters based on the similarity scores. A clustering machine learning model may apply a clustering algorithm (e.g., k-means clustering, mean-shift clustering, Gaussian mixture models, or hierarchical clustering) that uses similarity scores between a plurality of entities to cluster the plurality of entities.

In some embodiments, a similarity score describes a value corresponding to a measurement of similarity, or a strength of relationship, between a pair of entities. Similarity scores of a plurality of entities may be used by a clustering machine learning model to group the plurality of entities into clusters. According to various embodiments of the present disclosure, a similarity score between a pair of entities may be determined based on a comparison of their features (e.g., a set of features). In some embodiments, determining a similarity score between a pair of entities may comprise generating embeddings, e.g., using an embedding machine learning model, associated with a given set of features, selected as a basis for similarity comparison, for the pair of entities. As such, a similarity score between the pair of entities may be determined by using a distance function with the embeddings of the given features associated with the pair of entities. A distance function may comprise a mathematical formula that can be used to calculate a distance between the embeddings of the given features associated with the pair of entities, such as Euclidean distance, Manhattan distance, Minkowski distance, Jaccard distance, Cosine similarity, and any other types of distance measurements apparent to one of ordinary skill in the art.

In some embodiments, an embedding describes a numerical representation of one or more features associated with an entity. For example, an embedding of an entity may be expressed as a vector comprising one or more numbers representative of one or more features associated with the entity. In some embodiments, an embedding comprises a mapping of one or more features to one or more elements in a vector space. According to various embodiments of the present disclosure, embeddings may be generated for a pair of entities and used with a distance function to determine a similarity score between the pair of entities.

In some embodiments, an embedding machine learning model describes parameters, hyperparameters, and/or defined operations of a machine learning model that is configured to generate an embedding representative of one or more features associated with an entity. For example, an embedding machine learning model may be trained to convert entity features associated with population data, ancillary data, and external domain data into an embedding vector. As such, an embedding machine learning model may be configured to translate a plurality of features into a relatively low-dimensional vector space in the form of an embedding.

As described herein, in accordance with various embodiments of the present disclosure, a predictive machine learning model may be trained to predict whether candidate entities require resources based on ancillary features that do not explicitly indicate, but may implicitly imply, a need for one or more resources. Candidate entities may be ranked based on their similarity to entities clustered based on ancillary features combined with location data. This technique will lead to improved and more insightful detection of resource needs. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

In some embodiments, at step/operation 404, the predictive data analysis computing entity 106 trains a prediction machine learning model based on the one or more sets of the plurality of clusters.

In some embodiments, a prediction machine learning model describes parameters, hyperparameters, and/or defined operations of a machine learning model that is configured to rank one or more candidate entities based on one or more sets of a plurality of clusters. According to various embodiments of the present disclosure, a prediction machine learning model may be trained with one or more sets of a plurality of clusters, where each set of the plurality of clusters may be associated with a selected set of shared features. A prediction machine learning model may also be trained with a plurality of entities or one or more clusters identified (e.g., labeled) as not associated with respective one or more sets of shared features. In some embodiments, a prediction machine learning model comprises an ensemble machine learning model based on decision tree learning, such as gradient boosting, extreme gradient boosting, or random forest.

In some embodiments, at step/operation 406, the predictive data analysis computing entity 106 ranks, using the prediction machine learning model, one or more candidate entities based on the one or more sets of the plurality of clusters.

In some embodiments, a candidate entity describes one of a plurality of entities comprising a prediction dataset selected for ranking. A candidate entity may be ranked based on its similarity to a plurality of entities associated with one or more specific clusters from one or more sets of a plurality of clusters. In some embodiments, a candidate entity may be representative of an entity requiring a resource. According to various embodiments of the present disclosure, a prediction machine learning model is trained to rank one or more candidate entities such that one or more prediction-based actions may be performed to allocate one or more resources may be initiated based on the ranking of the one or more candidate entities.

Ranking the one or more candidate entities may comprise generating a prediction based on a relevance score, e.g., using a distance function, between the one or more candidate entities and a plurality of entities associated with one or more specific clusters from one or more sets of a plurality of clusters. In some embodiments, a prediction machine learning model may rank one or more candidate entities based on relevance with respect to one or more specific sets of shared features. For example, a prediction machine learning model may be trained to (i) rank one or more first candidate entities with respect to a first set of shared entities based on a first training dataset comprising a first set of clusters generated based on the first set of shared features, and (ii) rank one or more second candidate entities with respect to a second set of shared entities based on a second training dataset comprising a second set of clusters generated based on the second set of shared features. In some additional embodiments, a prediction machine learning model may generate a composite ranking of one or more candidate entities based on relevance with respect to a plurality of sets of shared features (e.g., the first set of shared features and the second set of shared features).

In some embodiments, at step/operation 408, the predictive data analysis computing entity 106 initiates the performance of one or more prediction-based actions based on the ranking of the one or more candidate entities. In some embodiments, the ranking of the one or more candidate entities may determine a priority, frequency, and scheduling of the performance of one or more prediction-based actions towards the one or more candidate entities. Initiating the performance of the one or more prediction-based actions based on the ranking of the one or more candidate entities comprises, for example, performing a resource-based action (e.g., allocation of resource), generating a diagnostic report, generating and/or executing action scripts, generating alerts or messages, or generating one or more electronic communications. The one or more prediction-based actions may further include displaying visual renderings of the aforementioned examples of prediction-based actions in addition to values, charts, and representations associated with the ranking of the one or more candidate entities using a prediction output user interface.

FIG. 5 is a flowchart diagram of an example process 500 for generating clustering parameters. In some embodiments, via the various steps/operations of the process 500, a plurality of clustering parameters may be generated for use by the predictive data analysis computing entity 106 to generate a plurality of clusters.

In some embodiments, the process 500 begins at step/operation 502 when the predictive data analysis computing entity 106 extracts population data from a population dataset. The population data may comprise location and feature information associated with a plurality of entities.

In some embodiments, a population dataset describes a collection of data associated with characteristics or features of one or more entities. According to various embodiments of the present disclosure, population data comprises data that identifies or characterizes respective ones of one or more entities belonging to a group. As an example, population data may comprise, among other types of information, location and feature information that may be collected on or received from one or more entities. A group may be representative of an organization of one or more entities. In some embodiments, entities in a group may belong to, be serviced by, be affiliated with, or otherwise be associated with a resource or service provider. Population data may be stored, maintained, and under control of a resource or service provider.

In some embodiments, population data describes at least a portion of a population dataset. As a non-limiting example, population data may comprise geolocation data (or address), a plan identifier, an identification of a dual eligible special needs plan, race, age, and gender.

In some embodiments, location and feature information describes at least a portion of population data comprising (i) locations of one or more entities, and (ii) descriptive or qualitative features of the one or more entities. According to various embodiments of the present disclosure, location and feature information comprises addresses (either virtual or physical), identifiers, types, configurations or settings, age, versions, and any other type of specification information apparent to one of ordinary skill in the art. In some embodiments, location and feature information may also comprise a postal address and demographic statistics.

In some embodiments, at step/operation 504, the predictive data analysis computing entity 106 merges the population data with ancillary data from a first ancillary dataset and a second ancillary dataset. It is noted that the population data may also be merged with ancillary data from addition ancillary datasets other than the first and second ancillary datasets.

In some embodiments, an ancillary dataset describes a collection of data distinct from a population dataset. Ancillary datasets and a population dataset may be associated with, owned, controlled, stored, and/or maintained, for example, by a same resource or service provider. An ancillary dataset may comprise data used to supplement population data. According to various embodiments of the present disclosure, population data is merged with one or more ancillary datasets. Examples of data comprised in ancillary datasets include, but not limited to, operating condition or status data, diagnostics and history data, ratings and performance data, and classification data. In another example, ancillary datasets may comprise social determinants of health data (e.g., barriers indications, such as an identification of a Medicare savings program and/or low income subsidy, housing, nutrition, education, employment, transportation, financial, and health services), clinical profile data (medical/chronic conditions, number of emergency room visits, number of primary care physician visits, per member per month, pharmacy utilization, out-of-pocket cost, inpatient visits, and outpatient visits), and risk adjustment factor data.

In some embodiments, ancillary data describes to at least a portion of one or more ancillary datasets.

In some embodiments, at step/operation 506, the predictive data analysis computing entity 106 generates location data associated with the plurality of entities based on the merged population data.

In some embodiments, location data describes an identification of a real-world geographic or virtual location of an object. For example, location data may comprise a set of geographic coordinates, such as latitude and longitude, or one or more alphanumeric identifiers. Location data may be determined and/or collected via either active user/device-based information, or passive server-based lookup/data correlation. According to various embodiments of the present disclosure, location data is determined based on data (e.g., population data and/or ancillary datasets) comprising postal address, Global Positioning System (GPS) data, Internet Protocol (IP) address, Media Access Control (MAC) address, Radio Frequency (RF) systems, or metadata from files in formats, such as Exchangeable Image File Format (EXIF).

In some embodiments, at step/operation 508, the predictive data analysis computing entity 106 associates the location data with external domain data. In some embodiments, the location data may be associated with the external domain data at the census tract/block level.

In some embodiments, external domain data describes data distinct from population data and ancillary data. External domain data may be associated with, owned, controlled, stored, and/or maintained by, for example, a resource or service provider different from a resource or service provider associated with (as well as own, control, store, and/or maintain) a population dataset and one or more ancillary datasets. In some embodiments, external domain data may comprise open-source data, third-party data, government-provided data, non-profit organization data, or public domain data. Examples of external domain data include, but not limited to, standards/specifications data, census data (e.g., poverty, housing, transportation, education, and employment), community-contributed data, survey data, or statistical data for census tracts/blocks.

In some embodiments, at step/operation 510, the predictive data analysis computing entity 106 determines a plurality of distances between the plurality of entities based on the location data. According to various embodiments of the present disclosure, the predictive data analysis computing entity 106 can generate one or more sets of a plurality of clusters, each set comprising respective ones of the plurality of entities, wherein one of the one or more sets of the plurality of clusters is generated based on clustering parameters comprising (i) respective ones of the plurality of distances associated with the respective ones of the plurality of entities are within a relative distance boundary based on refinement criteria, and (ii) the respective ones of the plurality of entities comprising a first set of shared features or a second set of shared features. The first set of shared features and the second set of shared features may be determined based on population data merged with ancillary data, and an association of location data with external domain data. It is noted that the clustering parameters may include additional sets of shared features other than the first and second set of shared features.

In some embodiments, a distance boundary describes a geographical area within a boundary relative to a particular geographical point. For example, a distance boundary may comprise a radius around a central geographical point. A distance boundary may comprise a geographical area bounded by any of a variety of shapes, either regular, or irregular.

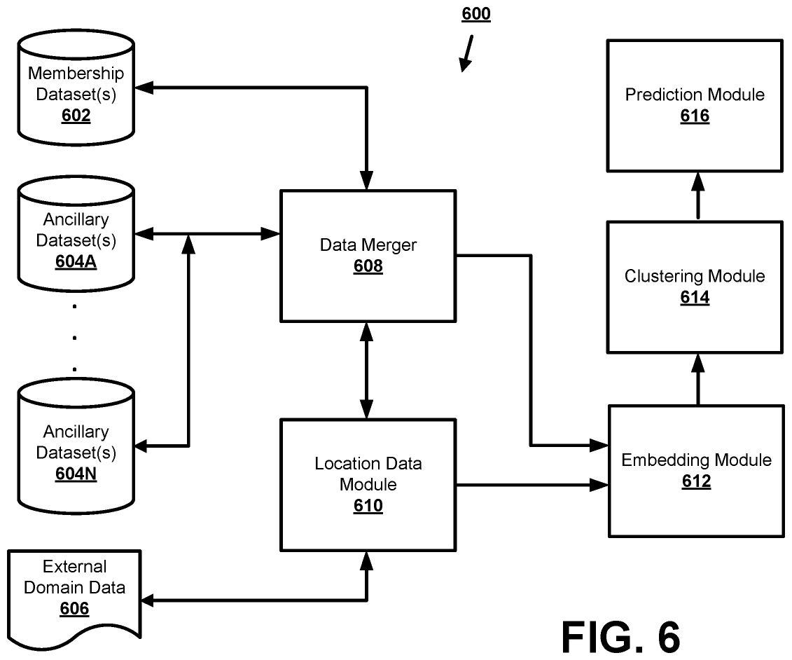

In some embodiments, the entity feature prediction machine learning framework 600 has the architecture that is depicted in FIG. 6. As further depicted in FIG. 6, the entity feature prediction machine learning framework 600 comprises data merger 608. Data merger 608 may be configured to extract population data (e.g., comprising location and feature information associated with a plurality of entities) from one or more population dataset 602 and merge the population data with ancillary data from a plurality of one or more ancillary dataset(s) 604A through 604N.

In some embodiments, the entity feature prediction machine learning framework 600 further comprises location data module 610. Location data module 610 may be configured to generate location data associated with a plurality of entities based on the population data merged with ancillary data. The location data module 610 may be further configured to associate the location data with external domain data 606 and determine a plurality of distances between the plurality of entities based on the location data.

In some embodiments, the entity feature prediction machine learning framework 600 further comprises embedding module 612. Embedding module 612 may be configured to generate an embedding representative of one or more features associated with an entity. In some embodiments, the embedding module 612 may comprise an embedding machine learning model trained to convert entity features associated with population data, ancillary data, and external domain data into an embedding vector. The embedding vector may be representative of a plurality of features in the form of a relatively low-dimensional vector space.

In some embodiments, the entity feature prediction machine learning framework 600 further comprises clustering module 614. Clustering module 614 may be configured to generate clusters from a plurality of entities. In some embodiments, the clustering module 614 may comprise a clustering machine learning model configured to (i) generate one or more clusters from a plurality of entities by receiving the plurality of entities in the form of embeddings, (ii) determine similarity scores between the plurality of entities by applying a distance function to the embeddings, and (iii) generate the one or more clusters based on the similarity scores. The clustering machine learning model may apply a clustering algorithm (e.g., k-means clustering, mean-shift clustering, Gaussian mixture models, or hierarchical clustering) that uses similarity scores between a plurality of entities to cluster the plurality of entities.

According to various embodiments of the present disclosure, clustering module 614 may be configured to generate one or more sets of a plurality of clusters, each set comprising respective ones of the plurality of entities, wherein (i) one of the one or more sets of the plurality of clusters is generated based on respective ones of the plurality of distances associated with the respective ones of the plurality of entities are within a relative distance boundary, and (ii) the respective ones of the plurality of entities comprises a first set of shared features or a second set of shared features, wherein the first set of shared features and the second set of shared features may be determined based on (a) the merged population data, and (b) the association of the location data with the external domain data. In some embodiments, the respective ones of the plurality of entities further comprises a third set of shared features, wherein the third set of shared features comprises an absence of the first set of shared features or an absence of the second set of shared features.

In some embodiments, the entity feature prediction machine learning framework 600 further comprises prediction module 616. Prediction module 616 may be configured to rank one or more candidate entities based on one or more sets of a plurality of clusters. In some embodiments, prediction module 616 may comprise a prediction machine learning model trained with one or more sets of a plurality of clusters, where each set of the plurality of clusters may be associated with a selected set of shared features. A prediction machine learning model may also be trained with a plurality of entities or one or more clusters identified (e.g., labeled) as not associated with respective one or more sets of shared features. Prediction module 616 may rank one or more candidate entities based on relevance with respect to one or more specific sets of shared features. For example, prediction module 616 may be configured to (i) rank one or more first candidate entities with respect to a first set of shared entities based on a first training dataset comprising a first set of clusters generated based on the first set of shared features, and (ii) rank one or more second candidate entities with respect to a second set of shared entities based on a second training dataset comprising a second set of clusters generated based on the second set of shared features. In some additional embodiments, prediction module 616 may generate a composite ranking of one or more candidate entities based on relevance with respect to a plurality of sets of shared features (e.g., the first set of shared features and the second set of shared features).

Accordingly, as described above, various embodiments of the present disclosure make important technical contributions to improving predictive ability and accuracy of predictive machine learning models by incorporating ancillary data with location data. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method comprising: merging, by the one or more processors, population data with ancillary data from a first ancillary dataset and a second ancillary dataset, wherein (i) the population data has been extracted from a population dataset, and (ii) the populating dataset comprises location and feature information associated with a plurality of entities; generating, by the one or more processors, location data associated with the plurality of entities based on the merged population data; associating, by the one or more processors, the location data with external domain data; determining, by the one or more processors, a plurality of distances between the plurality of entities based on the location data; generating, by the one or more processors, one or more sets of a plurality of clusters, each set comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and initiating, by the one or more processors, the performance of one or more prediction-based actions based on the ranking of the one or more candidate entities.

Example 2. The computer-implemented method of any of the preceding examples, wherein the prediction machine learning model comprises a gradient boosting machine learning model.

Example 3. The computer-implemented method of any of the preceding examples further comprising determining, by the one or more processors, a similarity score between a pair of the plurality of entities based on a comparison of one or more features associated with the pair of entities selected for comparison.

Example 4. The computer-implemented method of any of the preceding examples further comprising: generating, by the one or more processors, using an embedding machine learning model, embeddings for the one or more features; and determining, by the one or more processors, a similarity score for the pair of entities based on a distance function and the embeddings.

Example 5. The computer-implemented method of any of the preceding examples, wherein the distance function comprises one of a Euclidean distance, a Manhattan distance, a Minkowski distance, a Jaccard distance, or a Cosine similarity.

Example 6. The computer-implemented method of any of the preceding examples, wherein the first set of shared features is associated with barrier data based on the first ancillary dataset and the second set of shared features is associated with profile data based on the second ancillary dataset.

Example 7. The computer-implemented method of any of the preceding examples, wherein the respective ones of the plurality of entities associated with the one set of the plurality of clusters comprise per-cluster set similarity scores of at least a predetermined threshold.

Example 8. A computing apparatus comprising memory and one or more processors communicatively coupled to the memory, the one or more processors configured to: merge population data with ancillary data from a first ancillary dataset and a second ancillary dataset, wherein (i) the population data has been extracted from a population dataset, and (ii) the populating dataset comprises location and feature information associated with a plurality of entities; generate location data associated with the plurality of entities based on the merged population data; associate the location data with external domain data; determine a plurality of distances between the plurality of entities based on the location data; generate one or more sets of a plurality of clusters, each set comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and initiate the performance of one or more prediction-based actions based on the ranking of the one or more candidate entities.

Example 9. A computing apparatus of any of the preceding examples, wherein the prediction machine learning model comprises a gradient boosting machine learning model.

Example 10. A computing apparatus of any of the preceding examples, wherein the one or more processors are further configured to determine a similarity score between a pair of the plurality of entities based on a comparison of one or more features associated with the pair of entities selected for comparison.

Example 11. A computing apparatus of any of the preceding examples, wherein the one or more processors are further configured to: generate, using an embedding machine learning model, embeddings for the one or more features; and determine a similarity score for the pair of entities based on a distance function and the embeddings.

Example 12. A computing apparatus of any of the preceding examples, wherein the distance function comprises one of a Euclidean distance, a Manhattan distance, a Minkowski distance, a Jaccard distance, or a Cosine similarity.

Example 13. A computing apparatus of any of the preceding examples, wherein the first set of shared features is associated with barrier data based on the first ancillary dataset and the second set of shared features is associated with profile data based on the second ancillary dataset.

Example 14. A computing apparatus of any of the preceding examples, wherein the respective ones of the plurality of entities associated with the one set of the plurality of clusters comprise per-cluster set similarity scores of at least a predetermined threshold.

Example 15. One or more non-transitory computer-readable storage media including instructions that, when executed by one or more processors, cause the one or more processors to: merge population data with ancillary data from a first ancillary dataset and a second ancillary dataset, wherein (i) the population data has been extracted from a population dataset, and (ii) the populating dataset comprises location and feature information associated with a plurality of entities; generate location data associated with the plurality of entities based on the merged population data; associate the location data with external domain data; determine a plurality of distances between the plurality of entities based on the location data; generate one or more sets of a plurality of clusters, each set comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and initiate the performance of one or more prediction-based actions based on the ranking of the one or more candidate entities.

Example 16. One or more non-transitory computer-readable storage media of any of the preceding examples, wherein the prediction machine learning model comprises a gradient boosting machine learning model.

Example 17. One or more non-transitory computer-readable storage media of any of the preceding examples further comprising instructions that, when executed by the one or more processors, cause the one or more processors to determine a similarity score between a pair of the plurality of entities based on a comparison of one or more features associated with the pair of entities selected for comparison.

Example 18. One or more non-transitory computer-readable storage media of any of the preceding examples further comprising instructions that, when executed by the one or more processors, cause the one or more processors to: generate, using an embedding machine learning model, embeddings for the one or more features; and determine a similarity score for the pair of entities based on a distance function and the embeddings.

Example 19. One or more non-transitory computer-readable storage media of any of the preceding examples, wherein the distance function comprises one of a Euclidean distance, a Manhattan distance, a Minkowski distance, a Jaccard distance, or a Cosine similarity.

Example 20. One or more non-transitory computer-readable storage media of any of the preceding examples, wherein the respective ones of the plurality of entities associated with the one set of the plurality of clusters comprise per-cluster set similarity scores of at least a predetermined threshold.

Example 21. One or more non-transitory computer-readable storage media of any of the preceding examples, wherein the first set of shared features is associated with barrier data based on the first ancillary dataset and the second set of shared features is associated with profile data based on the second ancillary dataset.

1. A computer-implemented method comprising:
merging, by one or more processors, population data with ancillary data from a first ancillary dataset and a second ancillary dataset, wherein (i) the population data has been extracted from a population dataset, and (ii) the populating dataset comprises location and feature information associated with a plurality of entities;
generating, by the one or more processors, location data associated with the plurality of entities based on the merged population data;
associating, by the one or more processors, the location data with external domain data;
determining, by the one or more processors, a plurality of distances between the plurality of entities based on the location data;
generating, by the one or more processors, one or more sets of a plurality of clusters comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and
initiating, by the one or more processors, the performance of one or more prediction-based actions based on the ranking of the one or more candidate entities.

2. The computer-implemented method of claim 1, wherein the prediction machine learning model comprises a gradient boosting machine learning model.

3. The computer-implemented method of clam 1 further comprising determining, by the one or more processors, a similarity score between a pair of the plurality of entities based on a comparison of one or more features associated with the pair of entities selected for comparison.

4. The computer-implemented method of clam 3 further comprising:
generating, by the one or more processors and using an embedding machine learning model, embeddings for the one or more features; and
determining, by the one or more processors, a similarity score for the pair of entities based on a distance function and the embeddings.

5. The computer-implemented method of clam 4, wherein the distance function comprises one of a Euclidean distance, a Manhattan distance, a Minkowski distance, a Jaccard distance, or a Cosine similarity.

6. The computer-implemented method of claim 1, wherein the first set of shared features is associated with barrier data based on the first ancillary dataset and the second set of shared features is associated with profile data based on the second ancillary dataset.

7. The computer-implemented method of clam 1, wherein the respective ones of the plurality of entities associated with the one set of the plurality of clusters comprise per-cluster set similarity scores of at least a predetermined threshold.

8. A computing apparatus comprising memory and one or more processors communicatively coupled to the memory, the one or more processors configured to:
merge population data with ancillary data from a first ancillary dataset and a second ancillary dataset, wherein (i) the population data has been extracted from a population dataset, and (ii) the populating dataset comprises location and feature information associated with a plurality of entities;
generate location data associated with the plurality of entities based on the merged population data;
associate the location data with external domain data;
determine a plurality of distances between the plurality of entities based on the location data;
generate one or more sets of a plurality of clusters comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and
initiate the performance of one or more prediction-based actions based on the ranking of the one or more candidate entities.

9. The computing apparatus of claim 8, wherein the prediction machine learning model comprises a gradient boosting machine learning model.

10. The computing apparatus of claim 8, wherein the one or more processors are further configured to determine a similarity score between a pair of the plurality of entities based on a comparison of one or more features associated with the pair of entities selected for comparison.

11. The computing apparatus of claim 10 wherein the one or more processors are further configured to:
generate, using an embedding machine learning model, embeddings for the one or more features; and
determine a similarity score for the pair of entities based on a distance function and the embeddings.

12. The computing apparatus of claim 11, wherein the distance function comprises one of a Euclidean distance, a Manhattan distance, a Minkowski distance, a Jaccard distance, or a Cosine similarity.

13. The computing apparatus of claim 8, wherein the first set of shared features is associated with barrier data based on the first ancillary dataset and the second set of shared features is associated with profile data based on the second ancillary dataset.

14. The computing apparatus of claim 8, wherein the respective ones of the plurality of entities associated with the one set of the plurality of clusters comprise per-cluster set similarity scores of at least a predetermined threshold.

15. One or more non-transitory computer-readable storage media including instructions that, when executed by one or more processors, cause the one or more processors to:
merge population data with ancillary data from a first ancillary dataset and a second ancillary dataset, wherein (i) the population data has been extracted from a population dataset, and (ii) the populating dataset comprises location and feature information associated with a plurality of entities;
generate location data associated with the plurality of entities based on the merged population data;
associate the location data with external domain data;
determine a plurality of distances between the plurality of entities based on the location data;
generate one or more sets of a plurality of clusters comprising respective ones of the plurality of entities, wherein (i) one of the one or more sets of the plurality of clusters is generated based on respective ones of the plurality of distances associated with the respective ones of the plurality of entities are within a relative distance boundary, (ii) the respective ones of the plurality of entities comprises a first set of shared features or a second set of shared features, the first set of shared features and the second set of shared features determined based on (a) the merged population data, and (b) the association of the location data with the external domain data, and (iii) the one or more sets of the plurality of clusters is usable to train a prediction machine learning model to rank one or more candidate entities; and
initiate the performance of one or more prediction-based actions based on the ranking of the one or more candidate entities.

16. The one or more non-transitory computer-readable storage media of claim 15, wherein the prediction machine learning model comprises a gradient boosting machine learning model.

17. The one or more non-transitory computer-readable storage media of claim 15 further comprising instructions that, when executed by the one or more processors, cause the one or more processors to determine a similarity score between a pair of the plurality of entities based on a comparison of one or more features associated with the pair of entities selected for comparison.

18. The one or more non-transitory computer-readable storage media of claim 17 further comprising instructions that, when executed by the one or more processors, cause the one or more processors to:
generate, using an embedding machine learning model, embeddings for the one or more features; and
determine a similarity score for the pair of entities based on a distance function and the embeddings.

19. The one or more non-transitory computer-readable storage media of claim 18, wherein the distance function comprises one of a Euclidean distance, a Manhattan distance, a Minkowski distance, a Jaccard distance, or a Cosine similarity.

20. The one or more non-transitory computer-readable storage media of claim 15, wherein the respective ones of the plurality of entities associated with the one set of the plurality of clusters comprise per-cluster set similarity scores of at least a predetermined threshold.
